(19) United States
(12) Patent Application Publication
(10) Pub. No.: US 2012/0222464 A1
(43) Pub. Date: Sep. 6, 2012

(54) FILM-THICKNESS MEASURING DEVICE AND CALIBRATION METHOD THEREOF

(75) Inventors: Chih-sheng Ko, Shenzhen (CN); Chengming He, Shenzhen (CN)

(73) Assignee: Shenzhen China Star Optoelectronics Technology Co. Ltd, Shenzhen, Guangdong (CN)

(21) Appl. No.: 13/127,725

(22) PCT Filed: Mar. 25, 2011
(86) PCT No.: PCT/CN11/72147

§ 371 Date: May 5, 2011

(30) Foreign Application Priority Data
Mar. 4, 2011 (CN) 201110053410.9

(51) Int. Cl. G01D 18/00

(52) U.S. Cl. 73/1.01

(57) ABSTRACT

The present invention discloses a film-thickness measuring device and a calibration method thereof. The film-thickness measuring device has at least two fixing bases disposed in different calibration positions, a carrier machine table for carrying substrates and a measuring head. The measuring head receives a label of the present substrate being carried from the carrier machine table; obtains parameters of the calibration position that the label corresponds to from a saved corresponding relationship, and moves to a top of the calibration position that the obtained parameters correspond to, and then measures film-thickness of the calibration plate on the fixing base which is disposed in the calibration position to achieve calibration. The present invention automatically switches to corresponding calibration positions according to different substrates for calibrating, so as to prevent inconvenience caused by manual changing the calibration plates.

### FIELD OF THE INVENTION

The present invention relates to a film-thickness measuring device, especially to a film-thickness measuring device and a calibration method thereof that is able to execute calibration for different products.

### BACKGROUND OF THE INVENTION

A current manufacturing process of a thin-film transistor liquid crystal display (TFT LCD) is mainly divided into an upper substrate manufacturing process and a lower substrate manufacturing process. The lower substrate manufacturing process is to form a thin-film transistor array (TFT Array) on a mother glass substrate to form a TFT-Array substrate. The upper substrate manufacturing process is to coat another mother glass substrate with a photo-resist coating to form a color filter substrate. A means of measuring thickness of photo-resist coating is to measure the photo-resist coating on the mother substrate. Before measuring, a measuring head will execute calibration according to a calibration plate, and then start the film-thickness measurement for the photo-resist coating waiting to be measured.

Conventional color filter manufacturing technology further develops a Color-filter-On-Array manufacturing process (COA) that directly forms a color filter film on a TFT-Array substrate. Since a TFT-Array substrate differs from a mother glass substrate, once the photo-resist coating is coated, both substrates may have different effects on film-thickness measurement. Therefore, when executing film-thickness measurement, for film-thickness measurement on glass substrates of COA manufacturing process, it is necessary to replace the calibration plate of mother glass substrate with a calibration plate of TFT-Array substrate, so as to start new calibration.

With reference to FIG. 1, FIG. 1 is a schematic view of a conventional film-thickness measuring device. The conventional film-thickness device has a calibration area 90, a measuring area 91 and a measuring head 92 disposed above the calibration area 90 and the measuring area 91. The calibration area 90 has a fixing base 901 mounted thereon for placing a mother-glass calibration plate 900. The measuring area 91 is an area for placing a glass substrate 910 waiting to be measured. The measuring head 92 firstly moves to a top of the fixing base 901 to execute calibration by measuring the mother-glass calibration plate 900. The measuring head 92 then moves to the measuring area 91, and measures film-thickness of a photo-resist coating 911 on the glass substrate 910 waiting to be measured. When the product type is changed, a corresponding calibration plate for film-thickness measurement for the product also needs to be replaced, so as to obtain correct measuring parameters. Since conventional film-thickness measuring device only has one fixing base for placing calibration plate, calibration plates for different products need to be manually changed by operators, and the operators then manually calibrate the measuring head. And the obtain calibration value is also manually recorded.

However, manually changing calibration plates by operators may easily bring palm prints on the surface of the calibration plates, and calibration plates may be damaged during replacing. Furthermore, after changing the calibration plate, the measuring head needs to go through one time of manual calibration. Once shift changing or other reasons cause the operator to forget changing the calibration plate, it may cause abnormal measurement and thereby affect production capacity.

Hence, it is necessary to provide a film-thickness measuring device and a calibration method thereof to overcome the problems existing in the conventional technology.

### SUMMARY OF THE INVENTION

A primary object of the invention is to provide a film-thickness measuring device and a calibration method thereof to prevent problems that manually changing calibration plates may cause.

To achieve the above object, the present invention provides a film-thickness measuring device, and the film-thickness measuring device comprises:

at least two fixing base respectively disposed in different calibration positions for holding different calibration plates;

a carrier machine table disposed beside the fixing bases for carrying a substrate waiting to be measured and saving a label of the present substrate; and

a measuring head disposed above the fixing bases and the carrier machine table, receiving the label of the substrate from the carrier machine table, obtaining parameters of the calibration position that the label corresponds to from a saved corresponding relationship, and moving to a top of the calibration position that the obtained parameters correspond to, and then measuring film-thickness of the calibration plate on the fixing base disposed in the calibration position to achieve calibration, wherein the corresponding relationship is a corresponding relationship between the label and parameters of the calibration position.

In one embodiment of the present invention, the measuring head moves to a top of the carrier machine table after calibration, and then measures film-thickness of the substrate which the carrier machine table presently carries.

In one embodiment of the present invention, before obtaining parameters of the calibration position that the label corresponds to from a saved corresponding relationship, the measuring head further saves the label of the substrate that is presently being carried, and then determines whether the label of the present substrate is identical to the label of the substrate which the carrier machine table carried last time, if not identical, then executes the step of obtaining parameters of the calibration position that the label corresponds to from a saved corresponding relationship.

In one embodiment of the present invention, after determining the label of the substrate which the carrier machine table presently carries is identical to the label of the substrate which the carrier machine table carried last time, the measuring head moves to the top of the carrier machine table and measures film-thickness of the substrate which the carrier machine table presently carries.

In one embodiment of the present invention, when determining the label of the substrate which the carrier machine table presently carries is identical to the label of the substrate which the carrier machine table carried last time, the measuring head further determines whether a predetermined time is reached since the start of the last calibration, if not reached, the measuring head then moves to the top of the carrier machine table and measures film-thickness of the substrate which the carrier machine table presently carries; if reached, the measuring head then obtains parameters of the calibration position that the label corresponds to from a saved corresponding relationship, moves to the top of the calibration position which the obtained parameters correspond to and measures film-thickness of the calibration plate of the fixing base disposed in said calibration position to achieve calibration.

In one embodiment of the present invention, when determining the predetermined time is reached since the start of the last calibration, the measuring head then executes the step of obtaining parameters of the calibration position that the label corresponds to from a saved corresponding relationship.

The present invention further provides a calibration method of a film-thickness measuring device, and the film-thickness measuring device comprises at least two fixing bases, a carrier machine table and a measuring head, and the fixing bases are respectively disposed in different calibration positions for holding different calibration plates; the carrier machine table is disposed beside the fixing bases for carrying a substrate waiting to be measured and saves a label of the substrate which is presently being carried; the measuring head is disposed above the fixing bases and the carrier machine table; the calibration method is executed by the measuring head and comprises steps of:

receiving a label of the substrate which is presently being carried from the carrier machine table;

obtaining parameters of the calibration position that the label corresponds to from a saved corresponding relationship, wherein the corresponding relationship is a corresponding relationship between the label and parameters of the calibration position;

moving to a top of the calibration position that the obtained parameters correspond to; and

measuring film-thickness of the calibration plate on the fixing base disposed in the calibration position to achieve calibration.

In one embodiment of the present invention, before obtaining parameters of the calibration position that the label corresponds to from a saved corresponding relationship, the calibration method further comprises steps of:

saving the label of the substrate that is presently being carried; and

determining whether the label of the substrate which the carrier machine table presently carries is identical to the label of the substrate which the carrier machine table carried last time, if not identical, then executing the step of obtaining parameters of the calibration position that the label corresponds to from a saved corresponding relationship.

In one embodiment of the present invention, after determining the label of the substrate which the carrier machine table presently carries is identical to the label of the substrate which the carrier machine table carried last time, the measuring head moves to the top of the carrier machine table and measures film-thickness of the substrate which the carrier machine table presently carries.

In one embodiment of the present invention, when determining the label of the substrate which the carrier machine table presently carries is identical to the label of the substrate which the carrier machine table carried last time, the measuring head further determines whether a predetermined time is reached since the start of the last calibration, if not reached, the measuring head then moves to the top of the carrier machine table and measures film-thickness of the substrate which the carrier machine table presently carries.

Comparing with the conventional technologies, the present invention sets at least two fixing bases in different calibration positions for holding different calibration plates, and a measuring head receives the label of the present substrate and obtains parameters of the calibration position that the label corresponds to and moves to the top of the calibration position which the obtained parameters correspond to, so as to prevent inconvenience of manually changing calibration plates when the substrate type is changed.

### DESCRIPTION OF THE DRAWINGS

FIG. 1 is a schematic view of a film-thickness measuring device according to a prior art;

FIG. 2 is a schematic view of a first state of a film-thickness measuring device of a preferred embodiment in accordance with the present invention;

FIG. 3 is a schematic view of a second state of the film-thickness measuring device in FIG. 2; and

FIG. 4 is a flow chart of a calibration method of the film-thickness measuring device of a preferred embodiment in accordance with the present invention; and

FIG. 5 is a flow chart of the calibration method of the film-thickness measuring device of another preferred embodiment in accordance with the present invention.

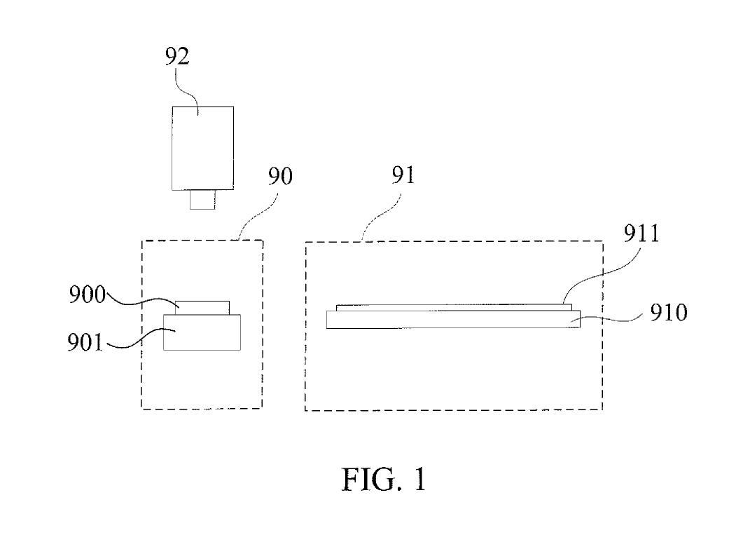

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

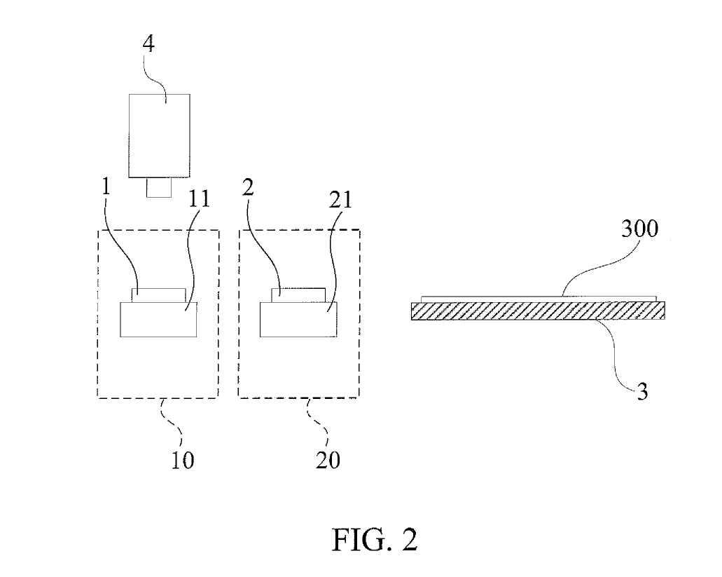

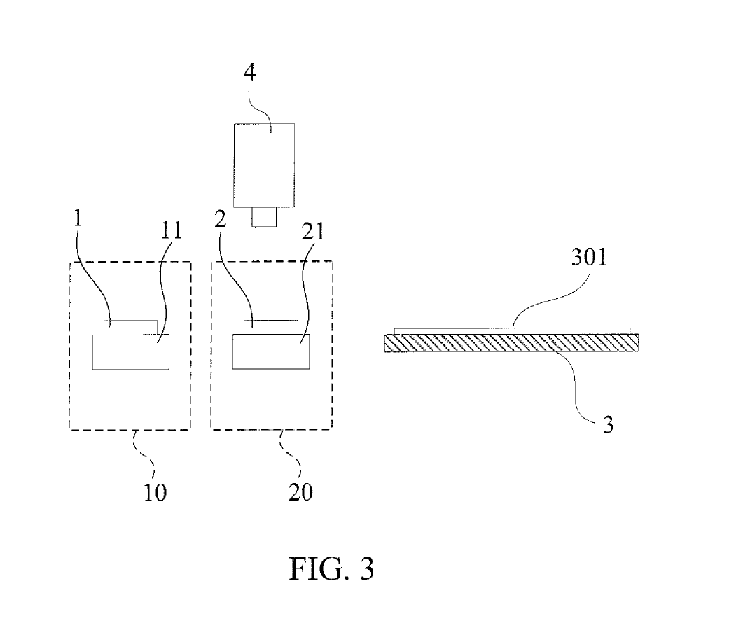

With reference to FIG. 2 and FIG. 3, FIG. 2 is a schematic view of a first state of a film-thickness measuring device of a preferred embodiment in accordance with the present invention and FIG. 3 is a schematic view of a second state of the film-thickness measuring device in FIG. 2. The film-thickness measuring device comprises a first fixing base 11, a second fixing base 21, a carrier machine table 3 and a measuring head 4.

With reference to FIGS. 2 and 3, the first fixing base 11 and the second fixing base 21 are respectively disposed in a first calibration position 10 and a second calibration position 20 to respectively holding a first calibration plate 1 and a second calibration plate 2. The first calibration plate 1 and the second calibration plate may respectively be a mother-glass-substrate calibration plate and a TFT-Array-substrate calibration plate.

The carrier machine table 3 is disposed beside the first fixing base 11 and the second fixing base 21. With reference to FIG. 2, the carrier machine table 3 carries a first substrate 300 that is waiting to be measured. With reference to FIG. 3, the carrier machine table 3 carriers a second substrate 301 that is waiting to be measured. The carrier machine table 3 may save a label of the substrate which is presently being carried. In this embodiment of the present invention, different types of substrates are sorted by different labels, for example, the label of a mother glass substrate is A, which corresponds to a mother-glass-substrate calibration plate; the label of a TFT-Array substrate is B, which corresponds to a TFT-Array-substrate calibration plate.

The measuring head 4 is disposed above the first fixing base 11, the second base 21 and the carrier machine table 3. With reference to FIGS. 2 and 3, when the carrier machine table 3 carries different substrates, the measuring head 4 moves correspondingly to tops of different calibration positions to execute related calibration.

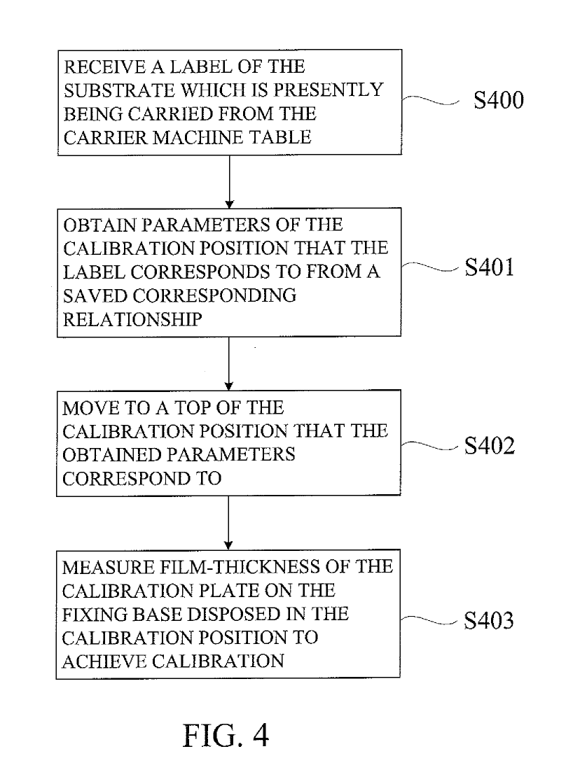

To describe the process of the aforementioned calibration in detail, please further refer to FIG. 4, wherein FIG. 4 is a flow chart of a calibration method of the film-thickness measuring device of a preferred embodiment in accordance with the present invention. The calibration method is executed by the measuring head and comprises following steps:

Step S400, the measuring head receives a label of the substrate which is presently being carried from the carrier machine table;

Step S401, the measuring head obtains parameters of the calibration position that the label corresponds to from a saved corresponding relationship, wherein the corresponding relationship is a corresponding relationship between the label and parameters of the calibration position;

Step S402, the measuring head moves to a top of the calibration position that the obtained parameters correspond to; and

Step S403, the measuring head measures film-thickness of the calibration plate on the fixing base disposed in the calibration position to achieve calibration.

For the embodiment in FIG. 2, with foregoing calibration method, the measuring head 4 receives the label of the first substrate 300 from the carrier machine table 3. The measuring head 4 saves a corresponding relationship, and the corresponding relationship is a corresponding relationship between labels and parameters of calibration positions. After receiving the label of the first substrate 300 from the carrier machine table 3, the measuring head 4 obtains the parameters of the first calibration position that the label of the first substrate 300 corresponds to from the saved corresponding relationship, and moves to the top of the first calibration position 10 that the obtained parameters correspond to, and then measures film-thickness of the first calibration plate 1 on the first fixing base 11 that is disposed in the first calibration position 10 to achieve calibration. After calibration, the measuring head 4 then moves to the top of the carrier machine table 3 and starts to measure film-thickness of the first substrate 300 that the carrier machine table 3 presently carries.

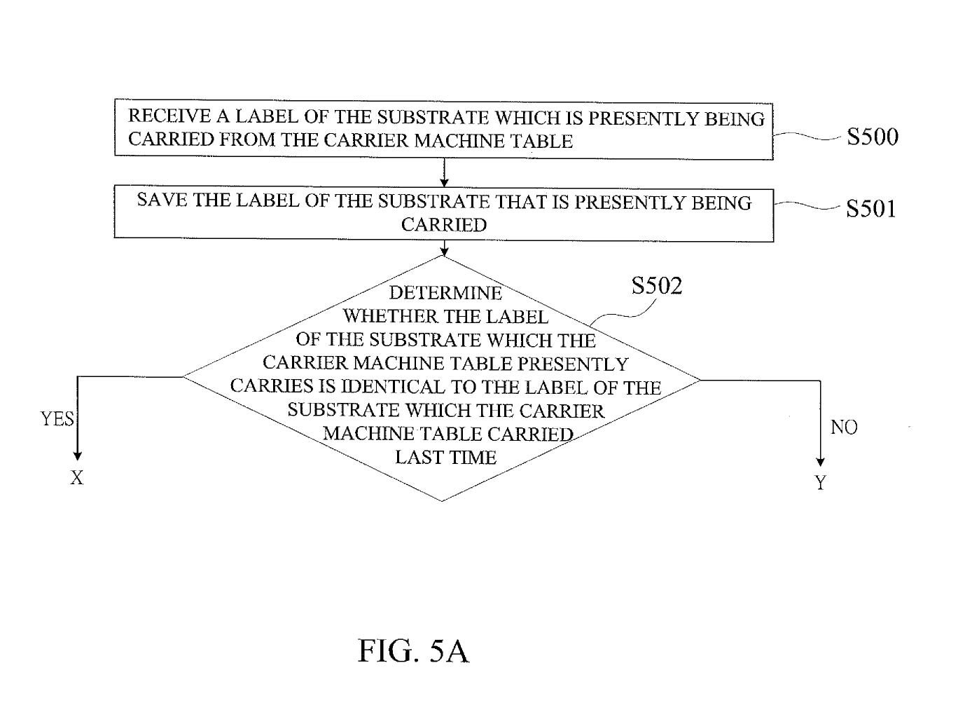

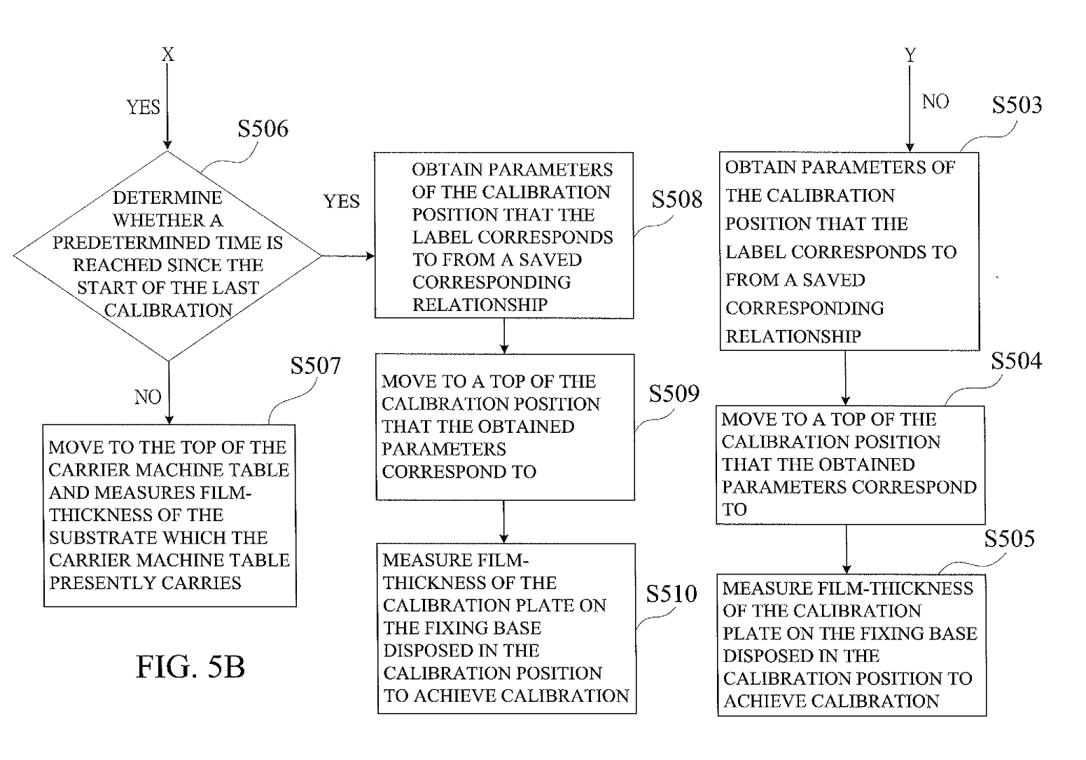

With further reference to FIG. 5, FIG. 5 is a flow chart of the calibration method of the film-thickness measuring device of another preferred embodiment in accordance with the present invention. The calibration method of the present invention is executed by the measuring head and comprise following steps:

Step S500, the measuring head receives a label of the substrate which is presently being carried from the carrier machine table;

Step S501, the measuring head saves the label of the substrate that is presently being carried;

Step S502, the measuring head determines whether the label of the substrate which the carrier machine table presently carries is identical to the label of the substrate which the carrier machine table carried last time or not, if not identical, then executes Step S503; otherwise executes Step S506;

Step S503, the measuring head obtains parameters of the calibration position that the label corresponds to from a saved corresponding relationship, wherein the corresponding relationship is a corresponding relationship between the label and parameters of the calibration position;

Step S504, the measuring head moves to a top of the calibration position that the obtained parameters correspond to;

Step S505, the measuring head measures film-thickness of the calibration plate on the fixing base disposed in the calibration position to achieve calibration;

Step S506, the measuring head determines whether a predetermined time is reached since the start of the last calibration, if not reached, executes Step S507; otherwise executes Steps S508 to S510;

Step S507, the measuring head moves to the top of the carrier machine table and measures film-thickness of the substrate which the carrier machine table presently carries;

Step S508, the measuring head obtains parameters of the calibration position that the label corresponds to from a saved corresponding relationship;

Step S509, the measuring head moves to a top of the calibration position that the obtained parameters correspond to; and

Step S510, the measuring head measures film-thickness of the calibration plate on the fixing base disposed in the calibration position to achieve calibration.

According to Step S501 of the embodiment in FIG. 5, the measuring head may further save the label of the first substrate 300 before obtaining the parameters of the first calibration position 10 that the label of the first substrate 300 correspond to.

With reference to FIG. 3, after measuring film-thickness of the first substrate 300, the carrier machine table then carries the second substrate 301 that is also waiting to be measured. The carrier machine table 3 further saves the label of the second substrate that is presently being carried. In the embodiment, the label of the second substrate 301 is different from the label of the first substrate 300.

According to step S500 to step S502 of the embodiment in FIG. 5, after receiving the label of the second substrate 301 that the carrier machine table presently carries, the measuring head 4 saves the label and determines whether the label of the second substrate 301 is identical to the label of the first substrate 300 which the carrier machine table 3 carried last time. If not identical, the measuring head then executes the step S503 of obtaining parameters of the calibration position that the label corresponds to from a saved corresponding relationship, the step S504 and the step S505, so as to achieve calibration. On the other hand, when the measuring head 4 determines that the label of the second substrate 301 which the carrier machine table 3 presently carries is identical to the label of the first substrate 300 which the carrier machine table 3 carried last time, then executes step S507. The measuring head 4 moves to the top of the carrier machine table 3 and measures film-thickness of the second substrate 301 that is presently carried by the carrier machine table 3. Since the first substrate 300 is different from the second substrate 301, the measuring thus determines that the labels of both substrates are not identical and then executes the step S503 of obtaining parameters of the calibration position that the label corresponds to from a saved corresponding relationship.

Besides, according to the step S506 of the embodiment in FIG. 5, when determining the label of the substrate which the carrier machine table 3 presently carries is identical to the label of the substrate which the carrier machine table 3 carried last time, the measuring head 4 further determines whether a predetermined time is reached since the start of the last calibration. If not reached, then execute the step S507. The measuring head 4 moves to the top of the carrier machine table 3 and measures film-thickness of the substrate which the carrier machine table 3 presently carries. On the other hand, when the measuring head 4 determines the predetermined time is reached since the start of the last calibration, then execute the step S508 to the step S510 to obtain parameters of the calibration position that the label corresponds to from the saved corresponding relationship, and move to the top of said calibration position that the obtained parameters of the calibration position correspond to, and finally measure film-thickness of the calibration plate on the fixing base disposed in the calibration position, so as to further ensure precision of measurement.

In conclusion, the present invention mainly sets at least two fixing bases in different calibration positions for holding different calibration plates, and uses a measuring head to receive a label of the present substrate sent from a carrier machine table. When the substrate type is changed such as from a mother glass substrate to a TFT-Array substrate, the measuring head will obtain parameters of the corresponding calibration position that the label corresponds to according to the present label from a predetermined corresponding relationship of labels to parameters of calibration positions. After that, the measuring head then moves to the top of the calibration position that the obtain parameters correspond to (or the top of the fixing base holding the TFT-Array-substrate calibration plate) and automatically starts new calibration and automatically saves the calibration data. After finishing calibration, the measuring head then moves back to the top of the carrier machine table to measure film-thickness of the TFT-Array substrate. Comparing with the conventional technologies, the present invention automates the calibration process for the film-thickness measuring device, so as to prevent inconvenience of manually changing calibration plates and also enhance entire working efficiency.

The present invention has been described with a preferred embodiment thereof and it is understood that many changes and modifications to the described embodiment can be carried out without departing from the scope and the spirit of the invention that is intended to be limited only by the appended claims.

1. A film-thickness measuring device, characterized in that: the film-thickness measuring device comprises:
at least two fixing base respectively disposed in different calibration positions for holding different calibration plates;
a carrier machine table disposed beside the fixing bases for carrying a substrate waiting to be measured and saving a label of the present substrate; and
a measuring head disposed above the fixing bases and the carrier machine table, receiving the label of the substrate from the carrier machine table, determining whether the label of the present substrate is identical to the label of the substrate which the carrier machine table carried last time, if not identical, then obtaining parameters of the calibration position that the label corresponds to from a saved corresponding relationship, and moving to a top of the calibration position that the obtained parameters correspond to, and then measuring film-thickness of the calibration plate on the fixing base disposed in the calibration position to achieve calibration, wherein the corresponding relationship is a corresponding relationship between the label and parameters of the calibration position.

2. The film-thickness measuring device as claimed in claim 1, characterized in that: after determining the label of the substrate the carrier machine table presently carries is identical to the label of the substrate the carrier machine table carried last time, the measuring head moves to a top of the carrier machine table and measures film-thickness of the substrate that the carrier machine table presently carries.

3. The film-thickness measuring device as claimed in claim 1, characterized in that: after determining the label of the substrate which the carrier machine table presently carries is identical to the label of the substrate which the carrier machine table carried last time, the measuring head further determines whether a predetermined time is reached since the start of the last calibration, if not, the measuring head then moves to the top of the carrier machine table and measures film-thickness of the substrate which the carrier machine table presently carries; if reached, the measuring head then obtains parameters of the calibration position that the label corresponds to from a saved corresponding relationship, moves to the top of the calibration position which the obtained parameters correspond to and measures film-thickness of the calibration plate of the fixing base disposed in said calibration position to achieve calibration.

4. The film-thickness measuring device as claimed in claim 1, characterized in that: the substrate is a mother glass substrate coated with a photo-resist coating or a TFT-Array substrate coated with a photo-resist coating.

5. A film-thickness measuring device, characterized in that: the film-thickness measuring device comprises:
at least two fixing base respectively disposed in different calibration positions for holding different calibration plates;
a carrier machine table disposed beside the fixing bases for carrying a substrate waiting to be measured and saving a label of the present substrate; and
a measuring head disposed above the fixing bases and the carrier machine table, receiving the label of the substrate from the carrier machine table, obtaining parameters of the calibration position that the label corresponds to from a saved corresponding relationship, and moving to a top of the calibration position that the obtained parameters correspond to, and then measuring film-thickness of the calibration plate on the fixing base disposed in the calibration position to achieve calibration, wherein the corresponding relationship is a corresponding relationship between the label and parameters of the calibration position.

6. The film-thickness measuring device as claimed in claim 5, characterized in that: the measuring head moves to a top of the carrier machine table after calibration, and then measures film-thickness of the substrate which the carrier machine table presently carries.

7. The film-thickness measuring device as claimed in claim 6, characterized in that: before obtaining parameters of the calibration position that the label corresponds to from a saved corresponding relationship, the measuring head further saves the label of the substrate that is presently being carried, and then determines whether the label of the present substrate is identical to the label of the substrate which the carrier machine table carried last time, if not identical, then executes the step of obtaining parameters of the calibration position that the label corresponds to from a saved corresponding relationship.

8. The film-thickness measuring device as claimed in claim 7, characterized in that: after determining the label of the substrate which the carrier machine table presently carries is identical to the label of the substrate which the carrier machine table carried last time, the measuring head moves to the top of the carrier machine table and measures film-thickness of the substrate which the carrier machine table presently carries.

9. The film-thickness measuring device as claimed in claim 7, characterized in that: after determining the label of the substrate which the carrier machine table presently carries is identical to the label of the substrate which the carrier machine table carried last time, the measuring head further determines whether a predetermined time is reached since the start of the last calibration, if not, the measuring head then moves to the top of the carrier machine table and measures film-thickness of the substrate which the carrier machine table presently carries.

10. A calibration method of a film-thickness measuring device, characterized in that: the film-thickness measuring device comprises at least two fixing bases, a carrier machine table and a measuring head, and the fixing bases are respectively disposed in different calibration positions for holding different calibration plates; the carrier machine table is disposed beside the fixing bases for carrying a substrate waiting to be measured and saves a label of the substrate which is presently being carried; the measuring head is disposed above the fixing bases and the carrier machine table; the calibration method is executed by the measuring head and comprises steps of:
receiving a label of the substrate which is presently being carried from the carrier machine table;
obtaining parameters of the calibration position that the label corresponds to from a saved corresponding relationship, wherein the corresponding relationship is a corresponding relationship between the label and parameters of the calibration position;
moving to a top of the calibration position that the obtained parameters correspond to; and
measuring film-thickness of the calibration plate on the fixing base disposed in the calibration position to achieve calibration.

11. The calibration method of a film-thickness measuring device as claimed in claim 10, characterized in that: before obtaining parameters of the calibration position that the label corresponds to from a saved corresponding relationship, the calibration method further comprises steps of:
saving the label of the substrate that is presently being carried; and
determining whether the label of the substrate which the carrier machine table presently carries is identical to the label of the substrate which the carrier machine table carried last time, if not identical, then executing the step of obtaining parameters of the calibration position that the label corresponds to from a saved corresponding relationship.

12. The calibration method of a film-thickness measuring device as claimed in claim 11, characterized in that: after determining the label of the substrate which the carrier machine table presently carries is identical to the label of the substrate which the carrier machine table carried last time, the measuring head moves to the top of the carrier machine table and measures film-thickness of the substrate which the carrier machine table presently carries.

13. The calibration method of a film-thickness measuring device as claimed in claim 10, characterized in that: when determining the label of the substrate which the carrier machine table presently carries is identical to the label of the substrate which the carrier machine table carried last time, the measuring head further determines whether a predetermined time is reached since the start of the last calibration, if not reached, the measuring head then moves to the top of the carrier machine table and measures film-thickness of the substrate which the carrier machine table presently carries.

14. The calibration method of a film-thickness measuring device as claimed in claim 13, characterized in that: when determining the predetermined time is reached since the start of the last calibration, the measuring head then executes the step of obtaining parameters of the calibration position that the label corresponds to from a saved corresponding relationship.
